(19) United States
(12) Patent Application Publication
(10) Pub. No.: US 2020/0042654 A1
(43) Pub. Date: Feb. 6, 2020

(54) INFORMATION PROCESSING APPARATUS AND METHOD FOR SECURING FLOW PATH

(71) Applicant: FUJITSU LIMITED, Kawasaki-shi (JP)

(72) Inventor: Hideharu Matsushita, Yokohama (JP)

(73) Assignee: FUJITSU LIMITED, Kawasaki-shi (JP)

(21) Appl. No.: 16/454,112

(22) Filed: Jun. 27, 2019

(30) Foreign Application Priority Data
Aug. 2, 2018 (JP) 2018-145704

(51) Int. Cl. G06F 17/50

(52) U.S. Cl. CPC G06F 17/50; G06F 2217/80; G06F 2217/02

(57) ABSTRACT

An information processing apparatus includes a memory, and a processor coupled to the memory and the processor configured to represent a shape of a component with a plurality of meshes, when a portion of the shape of the component exists in a first mesh of the plurality of meshes, exchange the first mesh with a second mesh of the plurality of meshes, which is filled with the shape of the component, and when a designated flow path overlaps with the second mesh, replace the second mesh with the first mesh in which the designated flow path exists.

### CROSS-REFERENCE TO RELATED APPLICATION

This application is based upon and claims the benefit of the prior Japanese Patent Application No. 2018-145704, filed on Aug. 2, 2018, the entire contents of which are incorporated herein by reference.

### FIELD

The embodiments discussed herein are related to an information processing apparatus and a method for securing a flow path.

### BACKGROUND

In recent years, with the progress of high integration, high functionality, and miniaturization of electronic devices, an air portion (hereinafter also referred to as a flow path) for heat dissipation is decreasing. In addition, in the development of electronic devices, shortening a design period is also required, and it is important to generate a thermal analysis model suitable for a design process or a computational resource. For the thermal analysis model, an orthogonal mesh method of generating a mesh with an arbitrary grid or an unstructured mesh method of generating a mesh along the shape of a component is used. In the generation of the thermal analysis model, the design data of three-dimensional computer aided design (CAD) data may be used to shorten the generation period. In this case, since the scale of the thermal analysis model becomes enormous when the component shape is faithfully reproduced, a reduction to the scale of the thermal analysis model is performed so that the thermal analysis model may be analyzed within a practical analysis time.

Related techniques are disclosed in, for example, Japanese Laid-open Patent Publication No. 03-095680.

### SUMMARY

According to an aspect of the invention, an information processing apparatus includes a memory, and a processor coupled to the memory and the processor configured to represent a shape of a component with a plurality of meshes, when a portion of the shape of the component exists in a first mesh of the plurality of meshes, exchange the first mesh with a second mesh of the plurality of meshes, which is filled with the shape of the component, and when a designated flow path overlaps with the second mesh, replace the second mesh with the first mesh in which the designated flow path exists.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a flow path;

FIG. 2 is a diagram illustrating an example of an analysis procedure;

FIG. 3 is a diagram illustrating an example of an analysis procedure according to an embodiment;

FIG. 4 is a block diagram illustrating an example of a hardware configuration of an information processing apparatus according to an embodiment;

FIG. 5 is a block diagram illustrating an example of a functional configuration of the information processing apparatus according to the embodiment;

FIG. 6 is a diagram illustrating an example of a shape data storage unit;

FIG. 7 is a diagram illustrating an example of a flow path data storage unit;

FIG. 8 is a diagram illustrating an example of a material data storage unit;

FIG. 9 is a diagram illustrating an example of a pseudo component storage unit;

FIG. 10 is a diagram illustrating an example of a mesh parameter storage unit;

FIG. 11 is a diagram illustrating an example of a mesh data storage unit;

FIG. 12 is a diagram illustrating an example of the input of a flow path, the enlargement of a component, and the securement of a flow path by a pseudo component; and

FIG. 13 is a flowchart illustrating an example of a flow path securing processing according to an embodiment.

### DESCRIPTION OF EMBODIMENTS

When the scale of a thermal analysis model is reduced, a flow path may not be secured in the thermal analysis model. For this reason, at the final stage of generation of the thermal analysis model, it is visually confirmed manually whether or not a flow path required for design is secured, which requires a large number of processes. In addition, in evaluation of an analysis result after execution of the thermal analysis, when a mesh parameter of the thermal analysis model has a problem and an unexpected result is obtained, an analysis iteration occurs to correct the thermal analysis model and perform reanalysis. Therefore, it is difficult to generate a thermal analysis model in which a flow path is secured within a practical analysis time.

Hereinafter, an embodiment of a technique capable of securing a flow path with a mesh size which may be processed within a practical analysis time according to the present disclosure will be described in detail with reference to the accompanying drawings. In addition, the disclosed technique is not limited by the present embodiment, and the following embodiments may be combined as appropriate as long as no contradiction arises.

### EMBODIMENTS

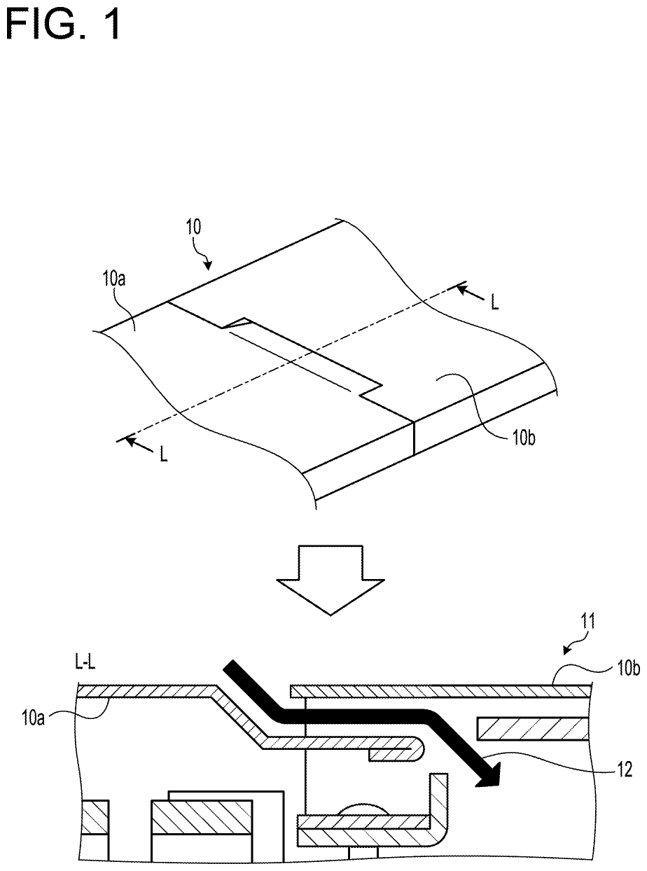

First, a flow path in an electronic device will be described with reference to FIG. 1. FIG. 1 is a diagram illustrating an example of a flow path. In FIG. 1, a flow path in a junction of a component 10a and a component 10b of a housing of an electronic device 10 is illustrated as an example. In the cross-sectional view 11 of the L-L cross section of the electronic device 10, it can be seen that a flow path 12 is provided between the component 10a and the component 10b. In the present embodiment, components will be described as an example of members.

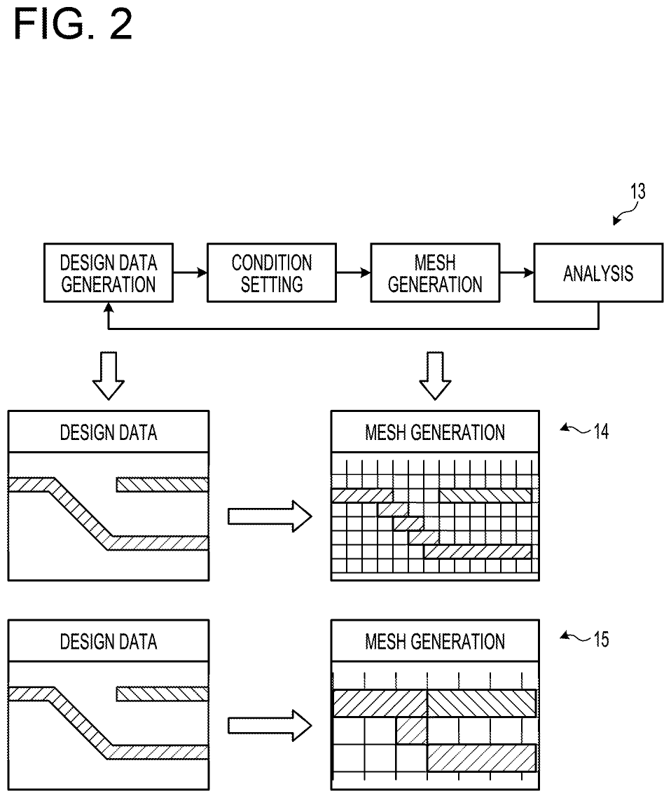

Next, an analysis procedure in a conventional thermal analysis model will be described with reference to FIG. 2. FIG. 2 is a diagram illustrating an example of an analysis procedure. As illustrated in FIG. 2, the analysis procedure 13 repeats a design data generation, a condition setting, a mesh generation, and an analysis until a thermal analysis model does not have any problem. In the analysis procedure 13, when generating a mesh from design data, it is conceivable that a flow path is secured by making the mesh finer as illustrated by a mesh 14. However, the mesh 14 has a large scale, for example, a mesh number of 10 billion, and thus, an analysis does not end within a practical analysis time.

Meanwhile, in the analysis procedure 13, when generating a mesh from design data for representing a shape of a component, as illustrated by a mesh 15, it is conceivable that analysis ends within a practical analysis time by simplifying components and reducing the number of meshes. However, in the mesh 15, a flow path between components is blocked due to the roughness of the mesh. In this case, mesh parameters or component shapes are corrected, and analysis is performed again. That is, an analysis iteration occurs due to deterioration in the accuracy of a thermal analysis model.

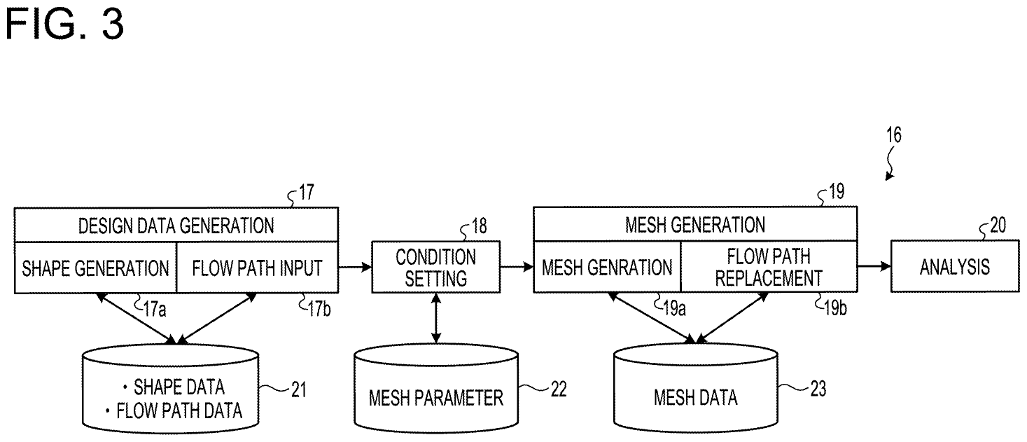

Then, an analysis procedure of a thermal analysis model according to an embodiment will be described using FIG. 3. FIG. 3 is a diagram illustrating an example of an analysis procedure according to an embodiment. As illustrated in FIG. 3, in the analysis procedure 16, the flow of major processings such as a design data generation processing 17, a condition setting processing 18, a mesh generation processing 19, and an analysis processing 20 is the same as the analysis procedure 13 in FIG. 2, but there is difference in the design data generation processing 17 and in the mesh generation processing 19. The design data generation processing 17 includes a shape generation processing 17a and a flow path input processing 17b. The shape generation processing 17a generates shape data of a component and stores the shape data in a storage unit 21. The flow path input processing 17b generates flow path data based on, for example, a flow path which is input by a user of an information processing apparatus who performs the analysis procedure 16, and stores the flow path data in the storage unit 21. That is, the design data generation processing 17 generates design data from the shape data and the flow path data.

The condition setting processing 18 sets a condition for mesh generation based on mesh parameters stored in a storage unit 22. The mesh generation processing 19 includes a mesh generation processing 19a and a flow path replacement processing 19b. The mesh generation processing 19a represents the design data generated in the design data generation processing 17 into meshes according to the condition set in the condition setting processing 18 to generate mesh data, and stores the mesh data in a storage unit 23. The flow path replacement processing 19b converts a flow path of the mesh data into a pseudo component and replaces a mesh in which the component overlaps with the pseudo component with a flow path (hereinafter also referred to as AIR) to reflect the flow path on the mesh data. The analysis processing 20 may perform thermal analysis using the mesh data in which the flow path is secured. Thus, in the analysis procedure 16, an analysis iteration does not occur.

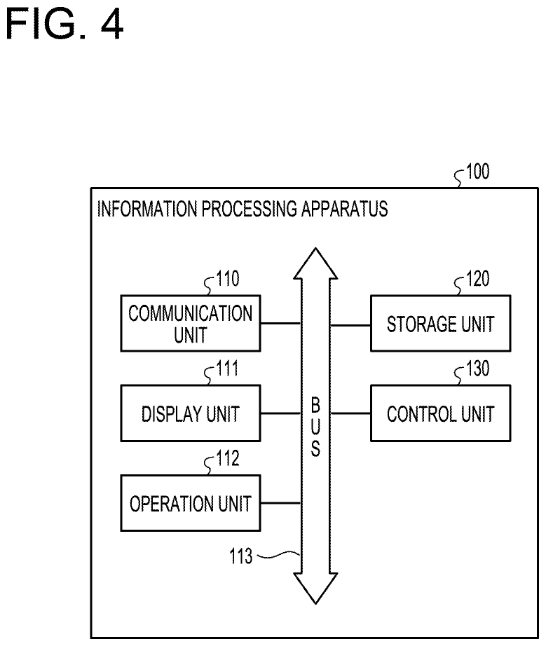

Next, a configuration of the information processing apparatus 100 will be described. FIG. 4 is a block diagram illustrating an example of a hardware configuration of an information processing apparatus according to an embodiment. As illustrated in FIG. 4, the information processing apparatus 100 includes a communication unit 110, a display unit 111, an operation unit 112, a storage unit 120, and a control unit 130. The communication unit 110, the display unit 111, the operation unit 112, the storage unit 120, and the control unit 130 are mutually connected via a bus 113. The information processing apparatus 100 may include various functional units of a known computer, for example, functional units such as various input devices or audio output devices, in addition to the functional units illustrated in FIG. 4.

The communication unit 110 is implemented by, for example, a network interface card (NIC). The communication unit 110 is a communication interface that is connected to another information processing apparatus by wire or wirelessly via a network (not illustrated) and manages communication of information with the other information processing apparatus.

The display unit 111 is a display device for displaying various pieces of information. The display unit 111 is implemented by, for example, a liquid crystal display that serves as a display device. The display unit 111 displays various screens such as a display screen which is input from the control unit 130 via a display control unit (not illustrated).

The operation unit 112 is an input device that receives various operations from the user of the information processing apparatus 100. The operation unit 112 is implemented by, for example, a keyboard or a mouse that serves as an input device. The operation unit 112 outputs an operation which is input by the user to the control unit 130 that serves as operation information. The operation unit 112 may be implemented by a touch panel that serves as an input device, for example, and the display device as the display unit 111 and the input device as the operation unit 112 may be integrated with each other.

The storage unit 120 is implemented by, for example, a storage device such as, for example, a semiconductor memory device such as a flash memory or a random access memory (RAM), a hard disk, or an optical disk. The storage unit 120 stores information used for a processing in the control unit 130.

The control unit 130 is implemented, for example, in such a manner that, for example, a central processing unit (CPU) or a micro processing unit (MPU) executes a program stored in an internal storage device using a RAM as a work area. In addition, the control unit 130 may be implemented, for example, by an integrated circuit such as an application specific integrated circuit (ASIC) or a field programmable gate array (FPGA).

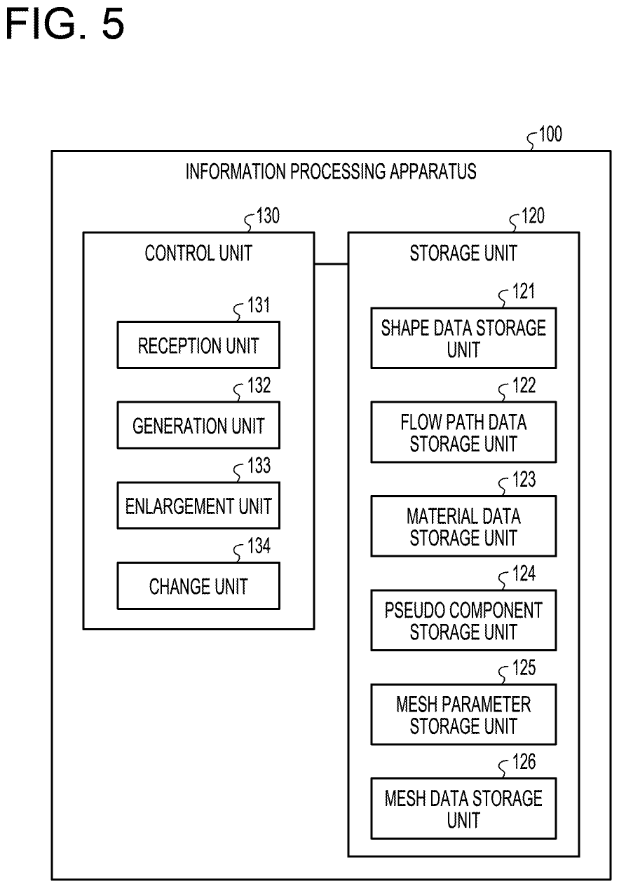

FIG. 5 is a block diagram illustrating an example of a functional configuration of the information processing apparatus according to the embodiment. As illustrated in FIG. 5, the storage unit 120 of the information processing apparatus 100 includes a shape data storage unit 121, a flow path data storage unit 122, a material data storage unit 123, a pseudo component storage unit 124, a mesh parameter storage unit 125, and a mesh data storage unit 126.

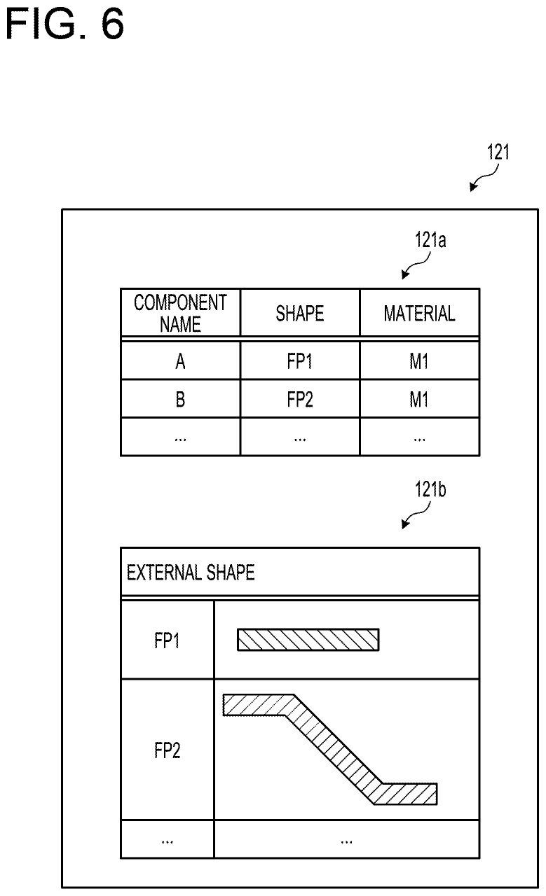

The shape data storage unit 121 stores information such as the shape or material of a component which is three-dimensional CAD data. FIG. 6 is a diagram illustrating an example of a shape data storage unit. As illustrated in FIG. 6, the shape data storage unit 121 has shape data 121a which correlates a component name with a shape and a material, and external shape data 121b which is three-dimensional data indicating the external shape of a component. The shape data 121a has items such as “component name,” “shape,” and “material.” Although not illustrated, the shape data storage unit 121 also stores coordinate information of each component.

The item “component name” is information for identification of a component. The item “shape” is information indicating a pointer that points to three-dimensional data corresponding to a relevant component in the external shape data 121b. For example, when the shape pointer is “FP1, ” three-dimensional data of the external shape data 121b corresponding to “FP1” is three-dimensional data indicating the external shape of a relevant component. The item “material” is information indicating the material of a component. The external shape data 121b stores a pointer corresponding to “shape” of the shape data 121a in association with three-dimensional data indicating the external shape. The three-dimensional data indicating the external shape is three-dimensional CAD data of each component.

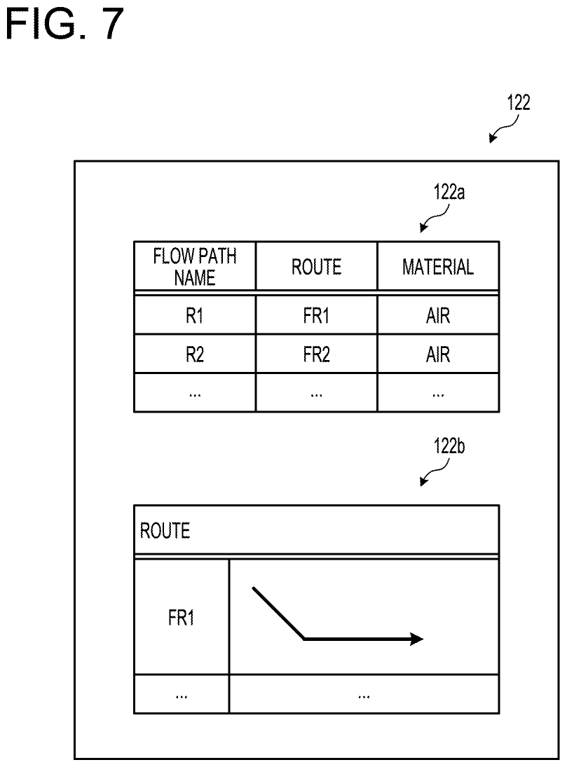

Referring back to FIG. 5, the flow path data storage unit 122 stores flow path data corresponding to a flow path for which an input is received in the information processing apparatus 100. FIG. 7 is a diagram illustrating an example of a flow path data storage unit. As illustrated in FIG. 7, the flow path data storage unit 122 includes flow path data 122a which correlates a flow path name, a route and a material, and route data 122b which is three-dimensional data indicating the route of a flow path. The flow path data 122a includes items such as “flow path name,” “route,” and “material.” Although not illustrated, the flow path data storage unit 122 also stores coordinate information of each flow path

The item “flow path name” is information for identification of a flow path. The item “route” is information indicating a pointer that points to three-dimensional data corresponding to a relevant flow path in the route data 122b. For example, when the route pointer is “FR1,” three-dimensional data of the route data 122b corresponding to “FR1” is three-dimensional data indicating the route of a relevant flow path. The item “material” is information indicating the material of a flow path. Since the air flows in a flow path normally, the material may be “AIR” indicating the air. The “material” may be a gas other than the air, and, for example, may be a rare gas such as helium or argon. The route data 122b stores a pointer corresponding to the “route” of the flow path data 122a in association with three-dimensional data indicating the route. The three-dimensional data indicating the route is, for example, three-dimensional CAD data corresponding to a flow path for which an input is received in three-dimensional CAD software (not illustrated) operating on the information processing apparatus 100.

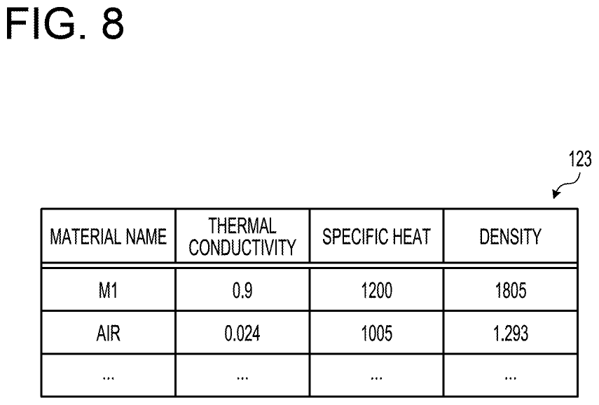

Referring back to FIG. 5, the material data storage unit 123 stores various parameters of the material of a component. FIG. 8 is a diagram illustrating an example of a material data storage unit. As illustrated in FIG. 8, the material data storage unit 123 includes items such as “material name,” “thermal conductivity,” “specific heat,” and “density.” The material data storage unit 123 is referred to when a thermal analysis model is executed.

The item “material name” is information indicating the name of a material. The item “thermal conductivity” is information indicating the thermal conductivity of a material and the unit thereof is [W/m·K]. The item “specific heat” is information indicating the specific heat of a material and the unit thereof is [J/kg·K]. The item “density” is information indicating the density of a material and the unit thereof is [kg/m³].

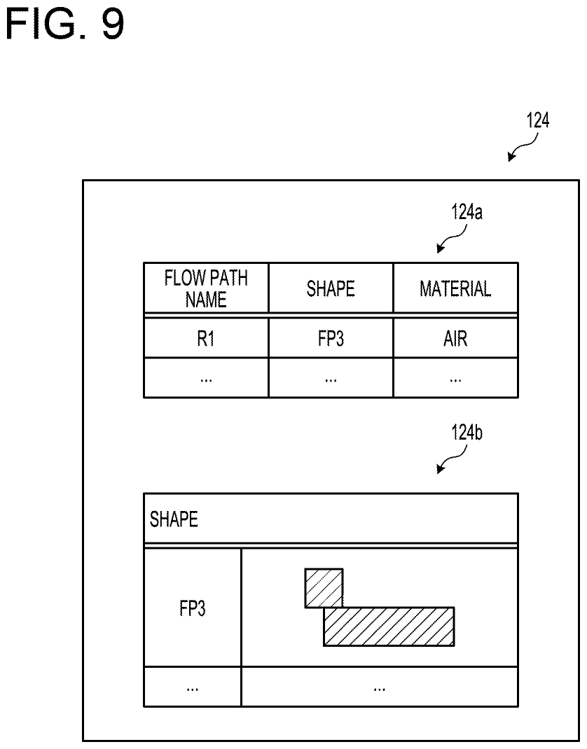

Referring back to FIG. 5, the pseudo component storage unit 124 stores data of a pseudo component which replaces a flow path. FIG. 9 is a diagram illustrating an example of a pseudo component storage unit. As illustrated in FIG. 9, the pseudo component storage unit 124 includes pseudo component data 124a which correlates a flow path name with a shape and a material and shape data 124b which is three-dimensional data indicating the external shape of a pseudo component. The pseudo component data 124a includes items such as “flow path name,” “shape,” and “material.” Although not illustrated, the pseudo component storage unit 124 also stores coordinate information of each pseudo component.

The item “flow path name” is information for identification of a flow path. The item “shape” is information indicating a pointer that points to three-dimensional data corresponding to a relevant flow path in the shape data 124b. For example, when the shape pointer is “FP3,” three-dimensional data of the shape data 124b corresponding to “FP3” is three-dimensional data indicating the shape of a pseudo component. The item “material” is information indicating the material of a pseudo component. The shape data 124b stores a pointer corresponding to the “shape” of the pseudo component data 124a in association with three-dimensional data indicating the shape. The three-dimensional data indicating the shape is three-dimensional CAD data of each pseudo component.

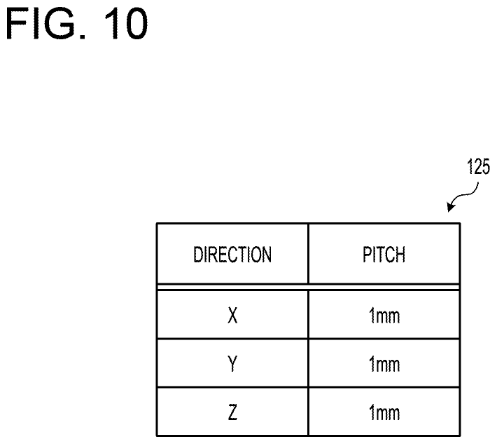

Referring back to FIG. 5, the mesh parameter storage unit 125 stores parameters of a mesh which represents design data. FIG. 10 is a diagram illustrating an example of a mesh parameter storage unit. As illustrated in FIG. 10, the mesh parameter storage unit 125 includes items such as “direction” and “pitch.” The item “direction” is information indicating each axis in three-dimensional directions of a mesh. The “pitch” is information indicating a mesh spacing.

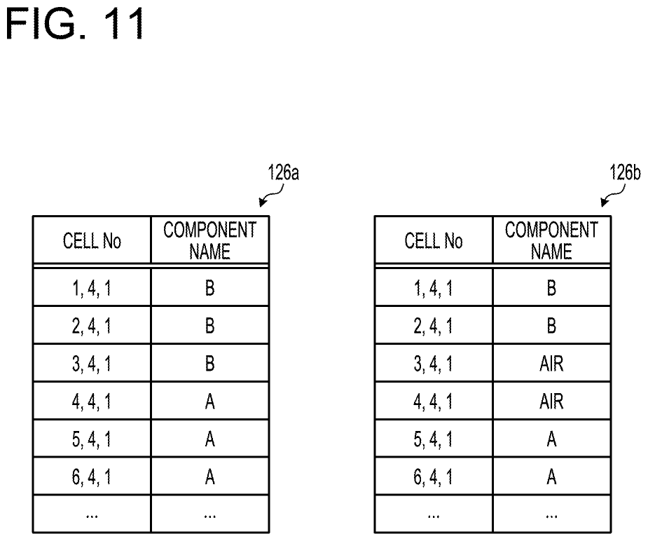

Referring back to FIG. 5, the mesh data storage unit 126 stores mesh data. FIG. 11 is a diagram illustrating an example of a mesh data storage unit. In FIG. 11, as the mesh data storage unit 126, a mesh data storage unit 126a before replacement to AIR (flow path) and a mesh data storage unit 126b after replacement to AIR are illustrated with respect to a mesh corresponding to a flow path. The mesh data storage unit 126 has items such as “cell No” and “component name.” The item “cell No” is information for identification of each mesh by the value of each X, Y, or Z axis. The mesh is also called a cell. The item “component name” is information indicating a component in a relevant mesh.

In an example of FIG. 11, component names corresponding to cell Nos. “3, 4, 1” and “4, 4, 1” are “B” and “A” in the mesh data storage unit 126a, but both are replaced with “AIR” in the mesh data storage unit 126b.

Referring back to FIG. 5, the control unit 130 of the information processing apparatus 100 includes a reception unit 131, a generation unit 132, an enlargement unit 133, and a change unit 134, and implements or executes functions or operations of an information processing to be described later. An internal configuration of the control unit 130 is not limited to the configuration illustrated in FIG. 5, and any other configuration may be possible as long as it performs an information processing to be described later.

The reception unit 131 receives an input of shape data from the user of the information processing apparatus 100. That is, the reception unit 131 receives an input of three-dimensional CAD data. Here, the input of the three-dimensional CAD data may be performed by three-dimensional CAD software (not illustrated) operating on the information processing apparatus 100, or an input of three-dimensional CAD data generated by another information processing apparatus may be received. The reception unit 131 stores the received shape data in the shape data storage unit 121.

In addition, the reception unit 131 receives an input of a flow path from the user of the information processing apparatus 100. The reception unit 131 receives, for example, an input of a flow path in three-dimensional CAD software (not illustrated) operating on the information processing apparatus 100. The reception unit 131 stores the received flow path in the flow path data storage unit 122 as flow path data. That is, the reception unit 131 generates design data for generating a thermal analysis model from the shape data and the flow path data. That is, a designated flow path between components (members) is included in the design data. The reception unit 131 may receive an input of design data based on shape data and flow path data generated by another information processing apparatus. The reception unit 131 outputs a mesh data generation instruction to the generation unit 132 when the design data is generated.

The mesh data generation instruction is input to the generation unit 132 from the reception unit 131. The generation unit 132 refers to the shape data storage unit 121, the flow path data storage unit 122, and the mesh parameter storage unit 125 based on the mesh data generation instruction, and represents design data into meshes using a designated mesh parameter to generate mesh data. That is, the generation unit 132 generates mesh data by representing design data serving as an analysis target into meshes generated by, for example, an orthogonal mesh method. The generation unit 132 stores the generated mesh data in the mesh data storage unit 126 and outputs an enlargement instruction to the enlargement unit 133.

When the enlargement instruction is input from the generation unit 132, the enlargement unit 133 refers to the mesh data storage unit 126 to enlarge a component in each mesh of the mesh data to the relevant mesh. That is, when a component (member) or a portion of the component is in one mesh, the enlargement unit 133 expands the component or the portion of the component into the one mesh. The enlargement unit 133 stores the mesh data for which the enlargement processing has ended in the mesh data storage unit 126. After storing the mesh data in the mesh data storage unit 126, the enlargement unit 133 outputs a change instruction to the change unit 134.

When the change instruction is input from the enlargement unit 133, the change unit 134 refers to the flow path data storage unit 122 and the pseudo component storage unit 124, and converts a flow path into a pseudo component. The change unit 134 selects one pseudo component and refers to the mesh data storage unit 126 to check an overlap between the pseudo component and the component in the mesh data. The change unit 134 determines whether or not there is an overlap between the pseudo component and the component based on the checked result. When it is determined that there is no overlap, the change unit 134 ends the check of the relevant pseudo component and proceeds to determination of whether or not all pseudo components have been checked.

Meanwhile, when it is determined that there is an overlap, the change unit 134 extracts a mesh in which the pseudo component and a component overlap. The change unit 134 replaces the extracted mesh with AIR, i.e., a flow path. The change unit 134 reflects the replaced mesh on the mesh data and stores the mesh data in the mesh data storage unit 126. When the reflection on the mesh data is completed, the change unit 134 proceeds to determination of whether or not all pseudo components have been checked.

When it is determined that there is no overlap or when the reflection of the replaced mesh on the mesh data ends, the change unit 134 determines whether or not all pseudo components in the design data have been checked. When it is determined that all pseudo components have not been checked, the change unit 134 selects one next pseudo component and repeats the check of an overlap between the pseudo component and the component. When it is determined that all pseudo components have been checked, the change unit 134 displays, for example, a message to the effect that a flow path is secured in the design data on the display unit 111 and ends the flow path securing processing.

In other words, when a designated flow path between members overlaps with a member (component) or a portion of the member which has been represented into meshes, the change unit 134 changes the member or the portion of the member which has been represented into meshes, into a flow path. In addition, the change unit 134 determines an overlap with the member or the portion of the member which has been represented into meshes, using a pseudo member corresponding to the designated flow path between members.

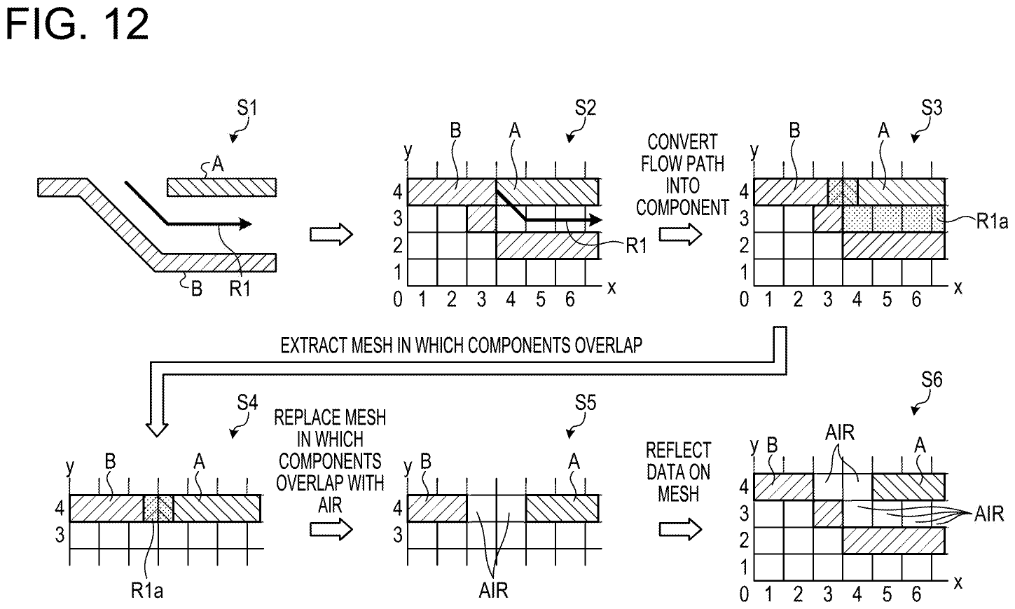

Here, a specific example of securing a flow path will be described using FIG. 12. FIG. 12 is a diagram illustrating an example of the input of a flow path, the enlargement of a component, and the securement of a flow path by a pseudo component. As illustrated in FIG. 12, the information processing apparatus 100 receives an input of a flow path R1 between a component A and a component B, for example, in three-dimensional CAD software (operation S1). In FIG. 12, the Z axis is omitted.

The information processing apparatus 100 represents design data into meshes to generate mesh data. The information processing apparatus 100 first enlarges the component A and the component B into meshes (operation S2). Next, the information processing apparatus 100 converts the flow path R1 into a pseudo component R1a (operation S3).

The information processing apparatus 100 extracts a mesh in which the component A and the component B overlap with the pseudo component R1a (operation S4). In the example of FIG. 12, since two meshes of coordinates (x, y)=(3, 4), (4, 4) overlap with each other, the two meshes are extracted. The information processing apparatus 100 replaces the extracted meshes, i.e., the meshes in which the components overlap with each other, with AIR (operation S5). In operations S4 and S5, the row of y =4 is focused, and the other rows are omitted.

The information processing apparatus 100 reflects the replacement of the two meshes of coordinates (3, 4), (4, 4) with AIR on the mesh data (operation S6). Thus, the information processing apparatus 100 may secure a flow path even when the meshes in mesh data are coarse.

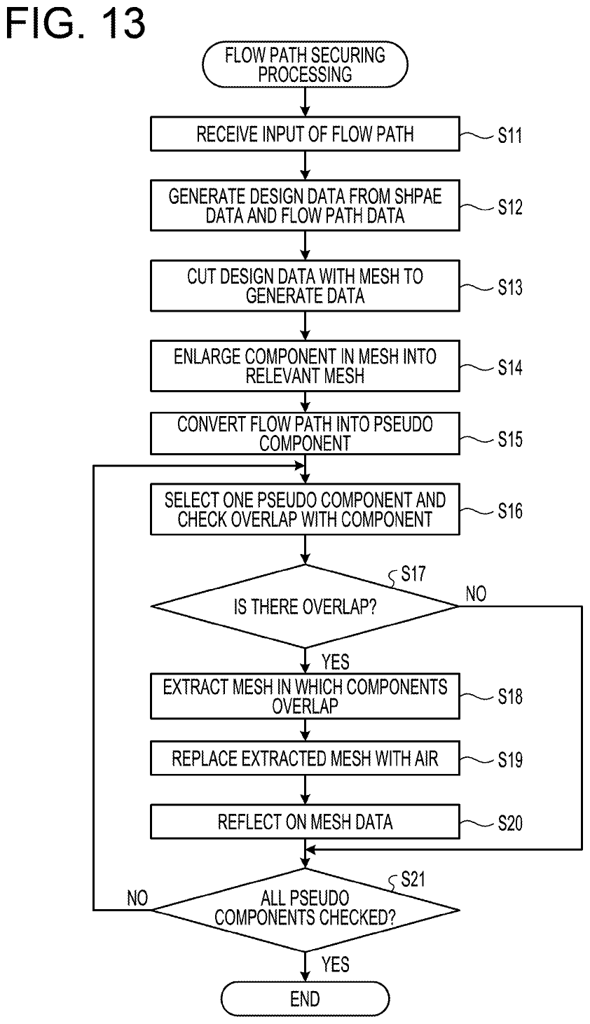

Next, an operation of the information processing apparatus 100 according to an embodiment will be described. FIG. 13 is a flowchart illustrating an example of a flow path securing processing according to an embodiment.

The reception unit 131 receives an input of shape data. The reception unit 131 stores the received shape data in the shape data storage unit 121. The reception unit 131 receives an input of a flow path, for example, in three-dimensional CAD software (not illustrated) operating on the information processing apparatus 100 (operation S11). The reception unit 131 stores the received flow path in the flow path data storage unit 122 as flow path data. That is, the reception unit 131 generates design data from the shape data and the flow path data (operation S12). When the design data is generated, the reception unit 131 outputs a mesh data generation instruction to the generation unit 132.

The generation unit 132 generates mesh data by representing the design data into meshes based on the mesh data generation instruction which is input from the reception unit 131 (operation S13). The generation unit 132 stores the generated mesh data in the mesh data storage unit 126 and outputs an enlargement instruction to the enlargement unit 133.

When the enlargement instruction is input from the generation unit 132, the enlargement unit 133 refers to the mesh data storage unit 126 and enlarges a component in each mesh of the mesh data to the relevant mesh (operation S14). When the mesh data for which the enlargement processing has ended is stored in the mesh data storage unit 126, the enlargement unit 133 outputs a change instruction to the change unit 134.

When the change instruction is input from the enlargement unit 133, the change unit 134 refers to the flow path data storage unit 122 and the pseudo component storage unit 124, and converts a flow path into a pseudo component (operation S15). The change unit 134 selects one pseudo component and refers to the mesh data storage unit 126 to check an overlap between the pseudo component and the component in the mesh data (operation S16). The change unit 134 determines whether or not there is an overlap between the pseudo component and a component based on the checked result (operation S17). When it is determined that there is no overlap (operation S17: “No”), the change unit 134 ends the check of the relevant pseudo component and proceeds to operation S21.

Meanwhile, when it is determined that there is an overlap (operation S17: “Yes”), the change unit 134 extracts a mesh in which the pseudo component and the component overlap with each other (operation S18). The change unit 134 replaces the extracted mesh with AIR (flow path) (operation S19). The change unit 134 reflects the replaced mesh on the mesh data and stores the mesh data in the mesh data storage unit 126 (operation S20). When the reflection on the mesh data is completed, the change unit 134 proceeds to operation S21.

The change unit 134 determines whether or not all pseudo components in the design data have been checked (operation S21). When it is determined that all pseudo components have not yet been checked (operation S21: “No”), the change unit 134 returns to operation S16. When it is determined that all pseudo components have been checked (operation S21: “Yes”), the change unit 134 displays, for example, a message to the effect that a flow path is secured in the design data the display unit 111 and ends the flow path securing processing. Thus, the information processing apparatus 100 may secure a flow path with a mesh size which can be represented within a practical analysis time. In addition, since the information processing apparatus 100 may secure a flow path by generating a thermal analysis model once, it is possible to reduce the number of iterations of thermal analysis model generation. That is, the information processing apparatus 100 may perform thermal analysis by generating a thermal analysis model in which a flow path is secured.

Although the thermal analysis model in the electronic device has been described in the above embodiment, the present disclosure is not limited thereto. For example, the embodiment may be applied to a thermal analysis model in a building such as a house. In this case, for example, it is possible to secure a flow path corresponding to a gap of a sash such as a window frame or a door.

Thus, the information processing apparatus 100 represents design data as an analysis target into meshes. In addition, when a member or a portion of the member is in one mesh, the information processing apparatus 100 expands the member or the portion of the member into the one mesh. In addition, when a designated flow path between members overlaps with the member or the portion of the member which has been represented into meshes, the information processing apparatus 100 changes the member or the portion of the member which has been represented into meshes, into a flow path. As a result, the information processing apparatus 100 may secure a flow path with a mesh size which can be represented within a practical analysis time.

In addition, the information processing apparatus 100 determines an overlap with the member or the portion of the member which has been represented into meshes, using a pseudo member corresponding to the designated flow path between members. As a result, the information processing apparatus 100 may secure a flow path even when the mesh is rough and the flow path between members is blocked.

In addition, in the information processing apparatus 100, a designated flow path between members is included in the design data. As a result, the information processing apparatus 100 may specify a flow path in the design data.

In addition, in the information processing apparatus 100, the mesh is a mesh generated by the orthogonal mesh method. As a result, the information processing apparatus 100 may reduce the amount of calculation of the thermal analysis model.

In addition, each component of each unit illustrated in the drawings is not necessarily physically configured as illustrated in the drawings. That is, a specific form of distribution and integration of each unit is not limited to the illustration, and all or a part thereof may be functionally or physically distributed or integrated in any unit according to various loads or usage conditions. For example, the generation unit 132 and the enlargement unit 133 may be integrated with each other. In addition, the illustrated respective processings are not limited to the above-described order, and may be performed simultaneously within the range in which the processing content does not contradict, or may be performed by changing the order.

In addition, the entirety or an arbitrary part of various processing functions performed by the control unit 130 may be executed on a CPU (or a microcomputer such as an MPU or a micro controller unit (MCU)). In addition, the entirety or any part of various processing functions may be executed on a program which is analyzed and executed by a CPU (or a microcomputer such as an MPU or MCU) or on hardware by wired logic.

The control unit 130 described in the above embodiment may execute the same function as the processing described in FIGS. 5 and 13, for example, by reading and executing a program. For example, the control unit 130 may execute the same processing as the embodiment described above by executing a process that executes the same processing as the reception unit 131, the generation unit 132, the enlargement unit 133, and the change unit 134.

These programs may be distributed via a network such as the Internet. In addition, these programs may be recorded on a computer-readable recording medium such as a hard disk, a flexible disk (FD), a CD-ROM, an MO, and a DVD, and may be executed by being read from the recording medium by a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to:
represent a shape of a component with a plurality of meshes;
when a portion of the shape of the component exists in a first mesh of the plurality of meshes, exchange the first mesh with a second mesh of the plurality of meshes, which is filled with the shape of the component; and
when a designated flow path overlaps with the second mesh, replace the second mesh with the first mesh in which the designated flow path exists.

2. The information processing apparatus according to claim 1,
wherein the processor is further configured to determine whether the designated flow path overlaps with the second mesh by using a pseudo component corresponding to the designated flow path.

3. The information processing apparatus according to claim 1,
wherein the processor is configured to represent the shape of the component and the designated flow path with the plurality of meshes.

4. The information processing apparatus according to claim 1,
wherein the plurality of meshes are generated by an orthogonal mesh method.

5. A non-transitory computer-readable recording medium storing a program that causes a computer to execute a procedure, the procedure comprising:
representing a shape of a component with a plurality of meshes;
when a portion of the shape of the component exists in a first mesh of the plurality of meshes, exchanging the first mesh with a second mesh of the plurality of meshes, which is filled with the shape of the component; and
when a designated flow path overlaps with the second mesh, replacing the second mesh with the first mesh in which the designated flow path exists.

6. The non-transitory computer-readable recording medium according claim 5,
wherein the procedure determines whether the designated flow path overlaps with the second mesh by using a pseudo component corresponding to the designated flow path.

7. The non-transitory computer-readable recording medium according claim 5,
wherein the procedure represents the shape of the component and the designated flow path with the plurality of meshes.

8. The non-transitory computer-readable recording medium according claim 5,
wherein the plurality of meshes are generated by an orthogonal mesh method.

9. A method for securing flow path comprising:
representing a shape of a component with a plurality of meshes;
when a portion of the shape of the component exists in a first mesh of the plurality of meshes, exchanging the first mesh with a second mesh of the plurality of meshes, which is filled with the shape of the component; and
when a designated flow path overlaps with the second mesh, replacing the second mesh with the first mesh in which the designated flow path exists, by a processor.
